(19) United States
(12) Patent Application Publication
(10) Pub. No.: US 2017/0107054 A1
(43) Pub. Date: Apr. 20, 2017

(54) Sto-Away

(71) Applicant: Anthony Martin Lupo, Sacramento, CA (US)

(72) Inventor: Anthony Martin Lupo, Sacramento, CA (US)

(21) Appl. No.: 14/339,193

(22) Filed: Jul. 23, 2014

(51) Int. Cl. B65F 1/14; B65B 67/12

(52) U.S. Cl. CPC B65F 1/1415; B65B 67/1238

(57) ABSTRACT

The Sto-Away is stronger and more durable than any other bag holder on the market. It has four legs for stability and strength, holds a 30-gallon construction debris trash bag and can stand up to heavy construction and other tough clean-up jobs. The nature of the assembly of the product gives it its strength.

The invention is a support for a trash bag which holds the trash bag open for easy filling. It can be quickly assembled or disassembled as necessary. It folds for compact storage and easy transport. It is constructed of an injection molded polypropylene upper frame, lower frame, and leg sections.

### BACKGROUND OF THE INVENTION

I am a general building contractor in the State of California. I have to travel to various parts of the state for work. I have to carry many tools with me to the job sites and I have no room for a large trash can as well. The jobs generate a significant amount of construction debris and I needed something to support the 42-gallon construction trash bags that I use and keep the trash bag open for easy filling but which does not take up a lot of room when not in use and therefore I invented the Sto-Away. Also, a trash bag with no support is a safety hazard on the job site or any other project, because it causes a trip hazard.

### BRIEF SUMMARY OF THE INVENTION

The general idea of the invention is to increase safety, productivity and cleanliness of a construction site without the bulk of a traditional trash can. It can be easily carried and stored in any vehicle, closet or toolbox when not in use.

### BRIEF DESCRIPTION OF THE DRAWINGS

FIG. 1 shows an exploded isometric view of the invention.

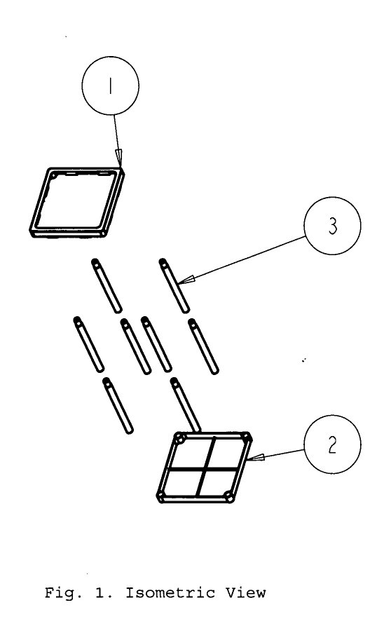

FIG. 2 shows, starting from left to right, a left side view, right side view, plan view and isometric view of the upper frame of invention.

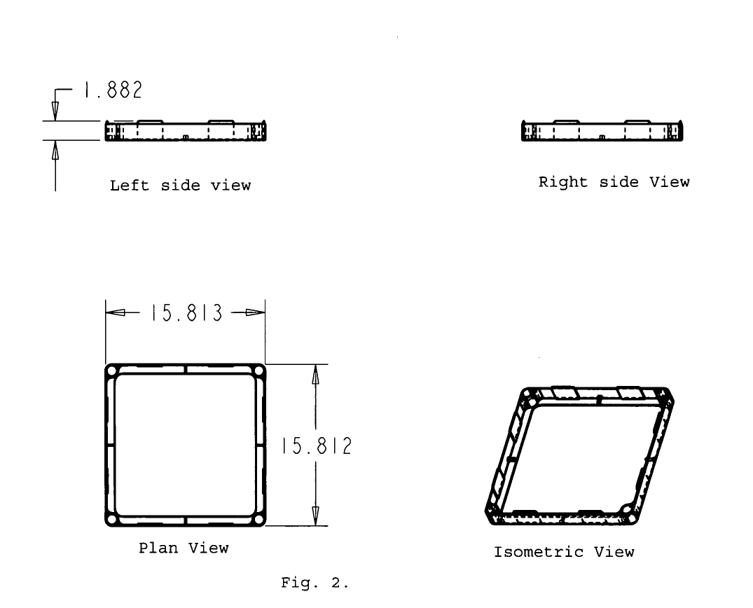

FIG. 3 shows, starting from left to right, left side view, right side view, plan view and isometric view of the lower frame of the invention.

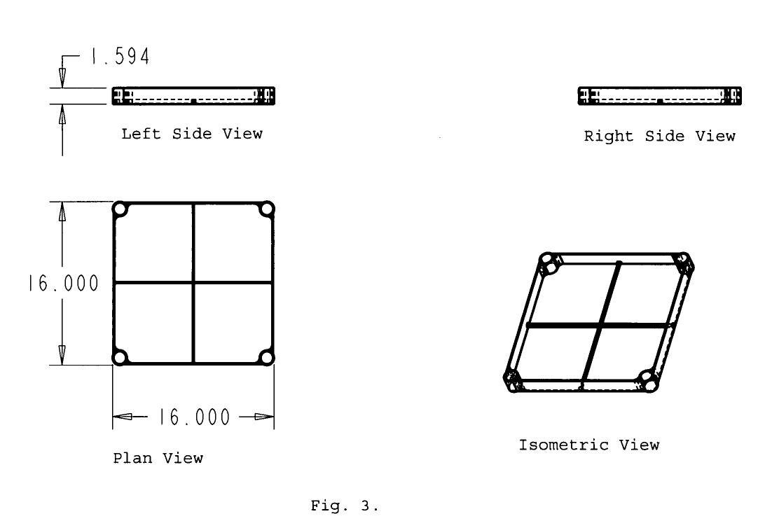

FIG. 4 shows a side view and top view of the leg sections.

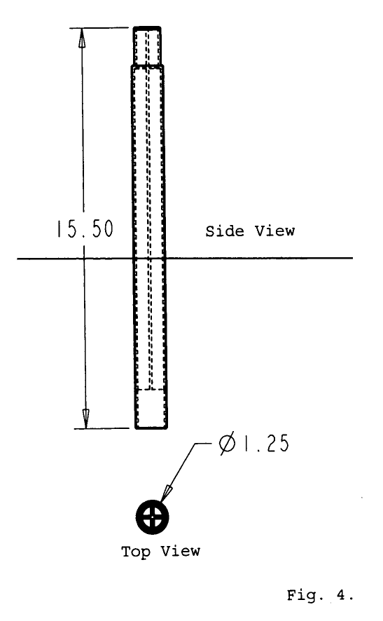

### DETAILED DESCRIPTION OF THE INVENTION

The Sto-Away is made of injected molded propylene and is easy to assemble and disassemble when not needed. The Sto-away is designed to be used with 42 gallon heavy duty construction debris disposable plastic bags. It can be used with any size bags on the market. It is useful for a wide variety of construction, recycling, yard work, and other clean-up tasks. It is useful for special occasion cleanups such as weddings, parties, picnics and catering. It is also heavy duty enough for use in the service industry and disaster cleanups. There is currently nothing on the market which has the strength, stability, compactability or durability of its construction and design.

1. The Sto-Away is the only bag holder on the market that stands up to large and heavy construction debris.

2. It will support the 30-gallon debris bags used on construction sites.

3. It has four support legs on each corner that lock into place to stabilize the bag and hold the weight.
